(19) United States
(12) Patent Application Publication
(10) Pub. No.: US 2024/0301949 A1
(43) Pub. Date: Sep. 12, 2024

(54) Method for Controlling a Hydrostatic Drive

(71) Applicant: Robert Bosch GmbH, Stuttgart (DE)

(72) Inventors: Ximing Wang, Neu-Ulm (DE); Salih Tetik, Nersingen (DE); Lukas Linder, Langenau (DE)

(21) Appl. No.: 18/563,789

(22) PCT Filed: May 20, 2022
(86) PCT No.: PCT/EP2022/063779

§ 371 Date: Nov. 22, 2023

(30) Foreign Application Priority Data
May 25, 2021 (DE) 10 2021 205 295.9

(51) Int. Cl. F16H 61/421; F15B 15/18; F16H 61/4183; F16H 61/431

(52) U.S. Cl. CPC F16H 61/421; F15B 15/18; F16H 61/4183; F16H 61/431

(57) ABSTRACT

A method for controlling a drive, which has a first hydraulic machine coupled to a drive machine and a second hydraulic machine coupled to an output to change one of the hydraulic machines from a pump operation to a motor operation and the other of the hydraulic machines from a motor operation to a pump operation includes controlling the pivoting angle of the other hydraulic machine so that the pivoting angle goes from a positive start pivoting angle to a negative target pivoting angle or from a negative start pivoting angle to a positive target pivoting angle. The control of the pivoting angle of the other hydraulic machine between the start pivoting angle and the target pivoting angle is limited such that the pivoting speed of the pivoting angle of the second hydraulic machine does not exceed a predefined value.

A generic drive has two hydraulic machines connected in an open hydraulic circuit with a displacement volume that can be adjusted to zero. A first one of the hydraulic machines can be coupled to a drive machine, for example a combustion drive or an electric machine, the second one to an output, for example a transmission or an axle. For example, the drive is a traction drive for a mobile work machine.

Control is carried out electrically/electronically via a control unit, preferably such that the working pressure of the drive is controlled by adjusting the displacement volume of the first hydraulic machine and the output torque by adjusting the displacement of the second hydraulic machine.

When reversing or decelerating the traction drive, the direction of the torque on the output-side unit must be changed. This is done by pivoting the pivoting cradle in the other direction. This changes the direction of flow of the fluid. For example, when changing from acceleration to deceleration of the vehicle, the fluid on the output-side unit is no longer drawn from the common pressure line between pump and motor, and conveyed into the tank line, but drawn from that tank line and conveyed into the common pressure line. In this state, the output-side unit changes from motor operation to pump operation. Failure to operate the unit properly may result in damage.

One phenomenon is cavitation. As the oil column in the suction line must be accelerated, this process must not be too dynamic. The cavitation at the suction port of the motor is dependent on the speed, pivoting angle, and pivoting speed.

In contrast, the object of the invention is to create a method for controlling the drive, via which the cavitation can be effectively prevented during reversing or decelerating.

### BRIEF SUMMARY

A hydrostatic drive, in particular a traction drive of a mobile work machine, has at least two hydraulic machines, of which at least a first hydraulic machine can be coupled to a drive machine and at least a second hydraulic machine can be coupled to a drive, in particular is coupled. They are fluidically connected, particularly in an open hydraulic circuit via a working line and also to a pressure medium sink, in particular a tank. Both may operate in pump operation and in motor operation as required. They are each designed with a displacement volume that can be adjusted for an efficient, demand-oriented pressure medium supply. In order to enable a change between motor and pump operation or a direction change of the torque, each of their displacement volumes can be adjusted to values left and right of zero. In particular, they are each configured as an axial piston machine in a swashplate design with a pivotable swashplate.

To adjust the displacement volume, the hydraulic machines each comprise at least one electrohydraulic adjustment unit. In the case of the swashplate design, the respective swashplate is guided therefrom. The respective electrohydraulic adjustment unit is effective in an adjustment direction and for this purpose comprises an electrically and/or electronically controllable valve device, via which a set pressure space of an actuator cylinder of this adjustment unit can optionally be connected to the working line and to a low pressure, and in intermediate positions in particular to both. In particular, a control unit of the drive is configured such that the working pressure in the working line can be regulated via the adjustment of the hydraulic machine that can be coupled to the drive machine, which is controlled by it, and a torque on the output can be controlled via the adjustment of the hydraulic machine that can be coupled to the output, which is controlled by it, and a displacement volume of the hydraulic machine there can be regulated. In particular, a respective actual value of the working pressure and the latter displacement volume is detected and electronically fed back to the control unit.

This concept of electronic feedback of the respective control variable, instead of hydraulic-mechanical feedback, is known from the Applicant's product range as the so-called “Electronified Open Circuit” or “EOC” hydraulic machine. Such a hydraulic machine is described in the application DE 10 2019 120 333 A1. A target torque on the output can in particular be transferred from a higher-level drive strategy, in particular a travel strategy, to the control unit. Such a drive is in particular known as a secondary controlled drive in an open hydraulic circuit.

In the method, one of the hydraulic machines (preferably the first hydraulic machine) is changed from a pump operation to a motor operation, and the other of the hydraulic machines (preferably the second hydraulic machine) is changed from a motor operation to a pump operation.

In the method, the pivoting angle of the output-side hydraulic machine is controlled, such that the pivoting angle goes from a positive start pivoting angle to a negative target pivoting angle or from a negative start pivoting angle to a positive target pivoting angle.

In this method, control of the pivoting angle of the output-side hydraulic machine between the start pivoting angle and the target pivoting angle is limited, such that the pivoting speed of the pivoting angle of the second hydraulic machine does not exceed a predefined value.

### BRIEF DESCRIPTION OF THE DRAWINGS

The present invention is described with reference to the accompanying figures, wherein the same reference numbers refer to the same parts and/or similar parts and/or corresponding parts of the system. Regarding the figures:

FIG. 1 schematically shows a circuit diagram of a hydrostatic drive configured as a traction drive in accordance with an exemplary embodiment of the present invention;

FIG. 2 schematically shows a hydraulic machine operating in the traction mode of the drive according to FIG. 1 as a hydraulic pump, according to one embodiment of the present invention;

FIG. 3 shows possible operating quadrants of the drive according to the figures;

FIG. 4 shows the behavior of a conventional drive when reversing or decelerating;

FIG. 5 shows the behavior of the drive according to the invention according to FIGS. 1 to 4 when reversing or decelerating.

### DETAILED DESCRIPTION

In the following, the present invention is described with reference to certain embodiments as shown in the accompanying figures. Nonetheless, the present invention is not limited to the particular embodiments described in the following detailed description and shown in the figures, but the described embodiments merely illustrate some aspects of the present invention, the scope of which is defined by the claims.

Further changes and variations of the present invention are clear to those skilled in the art. The present description thus encompasses any amendments and/or variations of the present invention, the scope of which is defined by the claims.

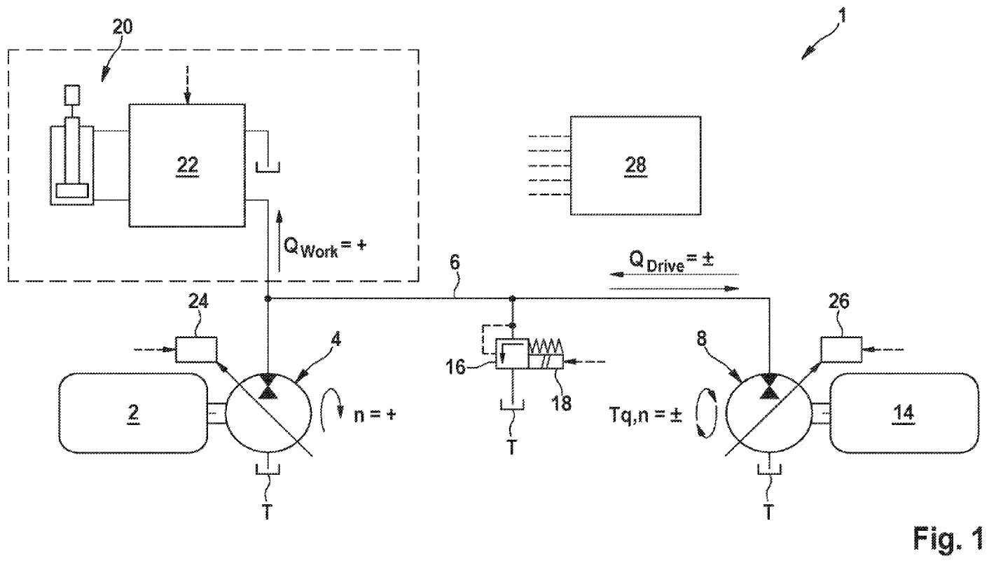

According to FIG. 1, a hydrostatic drive 1 configured as a traction drive has a first hydraulic machine 4 coupled to a drive machine 2 and a second hydraulic machine 8 fluidically connected thereto via a working line 6. The hydraulic machines 4, 8 each have an electrohydraulic adjustment unit 24, 26, via which their displacement volume can be adjusted. The second hydraulic machine 8 is coupled to an output-side transmission 14.

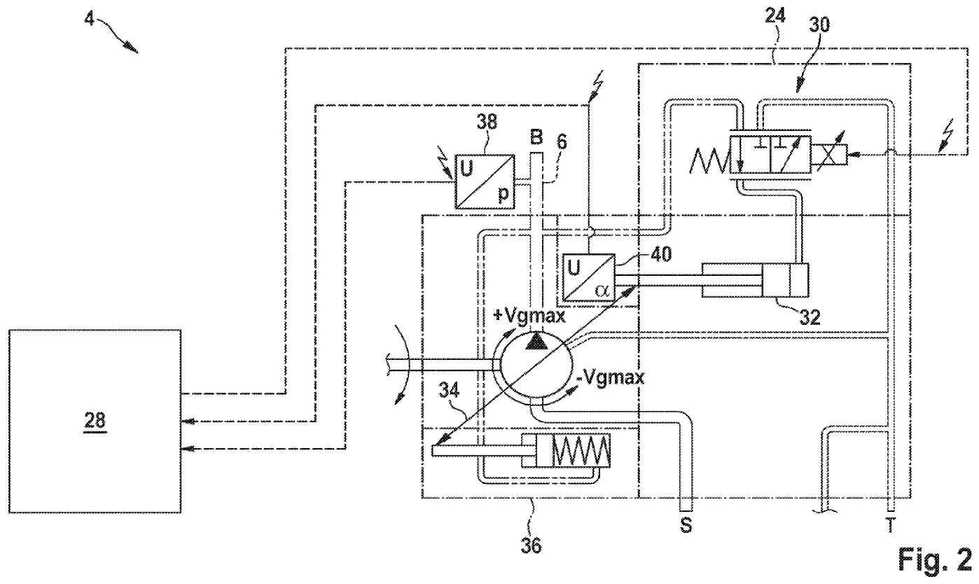

The respective hydraulic machine is in particular designed as an EOC or “Electronified Open Circuit” pump known from the Applicant's product range. The drive 1 is protected from positive pressure via a pressure relief valve 16, the target limit pressure of which can be adjusted by actuation of a solenoid 18. In the event of an intended high working pressure and the associated high target limit pressure, the solenoid 18 is preferably associated with a pilot or relay valve, via which the target limit pressure at the pressure relief valve 16 can then be set indirectly electrohydraulically instead of directly electrically by actuating the pilot valve. The electromagnetic direct actuation of the pressure relief valve 16 shown in FIG. 2, on the other hand, is appropriate in the case of a lower intended pressure range and the associated lower target limit pressure.

The drive 1 has a hydrostatic work consumer 20 configured as a hydraulic cylinder in the exemplary embodiment shown. To supply the pressure medium, the working line 6 is connected to the hydraulic cylinder 20 via a control valve block 22.

In intended operation, the drive machine 2 rotates in a constant direction of rotation, which is symbolized by n=+ in FIG. 1.

The hydraulic machines 4, 8 are both configured with adjustable displacement volume. For this purpose, as shown in FIG. 1, they each have an electrohydraulic adjustment unit 24, 26, from which a swashplate determining the respective displacement volume of the hydraulic machines 6, 8 is linked.

The hydraulic machines 4, 8 are configured with a displacement volume that can be pivoted, so that a volume flow reversal is enabled despite a consistent connection to the working line 6 and the pressure medium sink T, in particular for reversing the direction of travel and for transitioning from the traction operation to crawl operation and vice versa (i.e., during acceleration and deceleration).

The change in flow direction and torque direction on the output associated with reversing and the transition are outlined in FIG. 1.

The drive 1 has a control unit 28 for control purposes, which is signal-connected to at least the electrohydraulic adjustment units 24, 26, the solenoid 18 of the pressure relief valve 16, and the control valve 22.

FIG. 2 shows a more detailed representation of the first hydraulic machine 4 operating as a hydraulic pump in the intended traction operation. The following considerations also apply to the second hydraulic machine 8, with the difference that its drive shaft is coupled to the transmission 14 and the drive shaft of the first hydraulic machine 4 is coupled to the drive machine 2.

According to FIG. 2, the electrohydraulic adjustment unit 24 has an electromagnetically actuatable valve 30 that can be actuated by the control unit 28 having a pressure port connected to the working line 6 and having a tank port connected to the pressure medium sink T. Furthermore, the valve 30 has a port connected to a set pressure space of an adjustment cylinder 32 of the electrohydraulic adjustment unit 24.

In an un-powered state, a valve body of valve 30 is loaded by a spring to an end position in which working line 6 is connected to a set pressure space of adjustment cylinder 32. When the valve 30 is actuated electromagnetically, the set pressure space is connected to the low pressure T. Intermediate positions are possible in which the set pressure space is connected to both the working line 6 and the low pressure T.

Alternatively, the valve 30 of the electrohydraulic adjustment unit 24 may be configured inverted, that is, the valve body of the valve 30 is loaded by the spring in an end position in an un-powered state, in which the pressure medium sink T is connected to the set pressure space of the adjustment cylinder 32, whereas upon electromagnetic actuation of valve 30, the set pressure space is connected to working line 6.

Intermediate positions in which the set pressure space is connected to both the working line 6 and the low pressure T are of course possible in both variants, for example by means of a negative overlapping or underlapping of control edges.

The set pressure space of the actuator cylinder 32 is limited by an actuating piston from which the swashplate 34 of the first hydraulic machine 4 is loaded in the un-powered state of the valve 30 towards a (negative) maximum displacement volume −Vgmax. The −Vgmax value is defined in the present exemplary embodiment for the hydraulic machine 4 operating in motor operation, such that the maximum negative flow rate Q-max is decreased for a given direction of rotation and speed of the drive machine 2 from the hydraulic machine 4.

The +Vgmax value in the present exemplary embodiment is defined differently for the hydraulic machine 4 operating in pump operation, such that the maximum positive flow rate Q+max is provided by the hydraulic machine 4 for a given direction of rotation and speed of the drive machine 2.

A spring-loaded counter-piston of an electro-independent, hydraulic-mechanical adjustment unit 36 engages with the swash plate 34 in opposite directions of adjustment. Its set pressure space is permanently connected to the working line 6. The adjustment units 24, 36 act in the un-powered state as a function of the working pressure in the working line 6, such that above a system-specific working pressure, which depends on the piston area ratio, the spring force of the adjustment unit 36 and the speed, the electrohydraulic adjustment unit 24 adjusts the displacement volume Vg in the direction of positive maximum+Vgmax, and below this working pressure, the adjustment unit 36 adjusts the displacement volume Vg in the direction of negative maximum−Vgmax.

The drive 1 has a pressure sensor 38 connected to the working line 6 and a pivoting angle sensor 40 coupled to the swashplate 34 for control and/or regulation via the control unit 28.

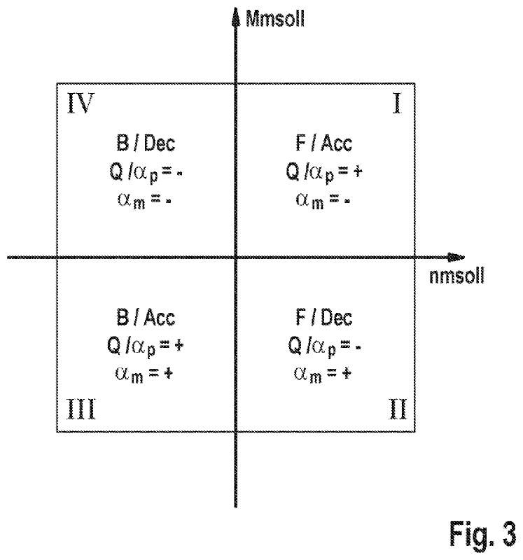

FIG. 3 shows possible operating quadrants of the drive 1. In the travel operation, the hydraulic machines 4, 8 are divided into four quadrants I-IV.

The first operating quadrant I is an accelerating forward travel at positive target drive speed nm and positive target torque Mm (+) of the second hydraulic machine 8 (“drive”). Here, the flow rate Q, or the pump pivoting angle ap, is positive (+) and a pivoting angle on the second hydraulic machine 8 is negative (−).

The second operating quadrant II is the decelerating forward travel at the positive target drive speed nm (+) but negative (−) target torque Mm (braking). The flow rate Q, or the pump pivoting angle aP, is negative (−) and the motor pivoting angle is positive (+).

The third operating quadrant III is an accelerating reverse travel with nm (−), Mm (−), Q, or aP (+) and am (+).

The fourth operating quadrant IV is a decelerating reverse travel with nm (−), Mm (+), Q, or aP (−) and am (−).

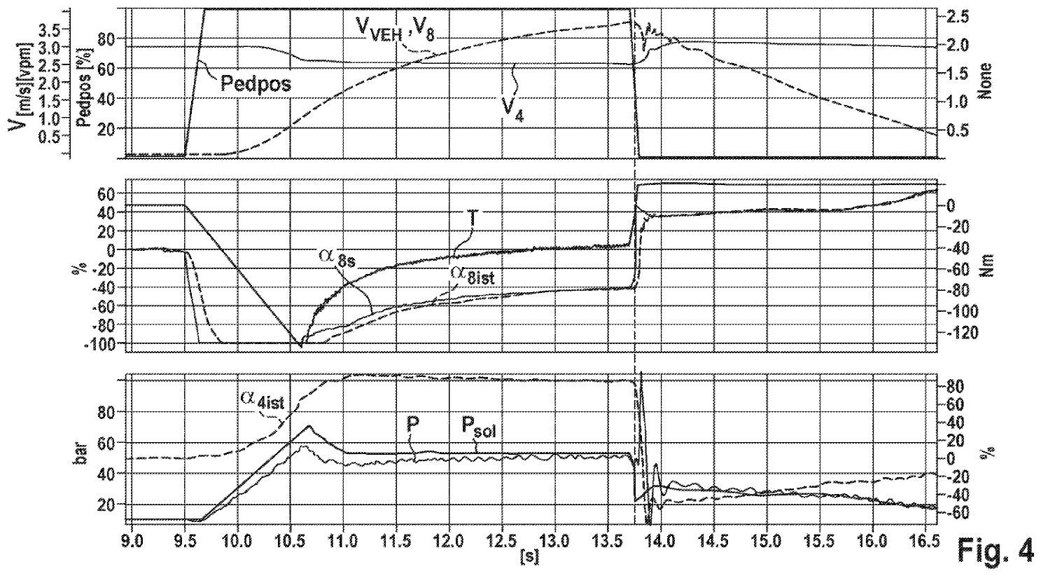

FIG. 4 shows a curve of various sizes when reversing or decelerating the traction drive. In particular, during reversing or decelerating, the direction of torque on the second hydraulic machine 8 must be changed. This is done by pivoting the adjustment unit 26 in the inverted direction, which changes the direction of flow of the fluid.

For example, when changing from acceleration to deceleration of the vehicle, the fluid on the output-side unit is no longer drawn from the common working line 6 between the first and second hydraulic machines 4, 8 and conveyed into the tank line, but drawn from this tank line and conveyed into the common working line 6. In this state, the second hydraulic machine 8 changes from motor operation to pump operation. Failure to operate the unit properly may result in damage.

As shown in FIG. 4, the traction drive travels forward at a positive speed vᵥₑₕ which increases gradually. The position of the actuating element, in particular the pedal Pedₚₒₛ, is kept constant up to the second 13.7. It is clear to those skilled in the art that this invention may also function with a different actuating element for operating the traction drive. The rotational speed V4 of the first hydraulic machine 4 is substantially constant up to the second 13.7. As shown in the lower portion of FIG. 4, both the pivoting angle a₄ᵢₛₜ of the first hydraulic machine 4 and the pressure P generated by the first hydraulic machine 4 remain relatively constant up to the second 13.7.

In this embodiment, the second hydraulic machine 8 is torque-controlled and pivoting angle-controlled via the control unit 28 and the adjustment unit 26 associated therewith. The torque specification T of the second hydraulic machine 8 lowers relatively slowly up to second 13.7, because the torque specification T is dependent on the ground speed vᵥₑₕ (for a constant actuation of the travel pedal, the absolute value of the torque specification T will gradually decrease or decline with the driving speed vᵥₑₕ).

As shown in the upper portion of FIG. 4, for the second 13.7, the driver changes the position of the pedal Pedp_{oS} to cause the traction drive to brake. For this reason, the control unit 28 senses that the desired torque has changed and the control unit 28 generates a new torque specification T and sends a signal to both adjustment units 24, 28.

In a further development, the method comprises a further step in which a change of the hydraulic machines from a motor operation to a pump operation and/or a zero passage of the displacement volumes is predicted and/or sensed.

Due to the signal received, the second hydraulic machine 8 goes from a start pivoting angle to a target pivoting angle, wherein the sign of the start pivoting angle is inverse to the sign of the target pivoting angle. In the exemplary embodiment shown in FIGS. 1 and 2, the start pivoting angle is negative and the target pivoting angle is positive. However, it may also be reversed in another exemplary embodiment. At the same time, the pivoting angle a₄ᵢₛₜ of the first hydraulic machine 4 is also pivoted towards 0 (because the target pressure Pₛₒₗ of the first hydraulic machine 4 is lowered).

The inventor has observed that the pivoting angle speed (i.e., the speed at which the pivoting angle pivots) of the second hydraulic machine 8, which in this embodiment is dependent on the torque specification T, affects cavitation because too high a pivoting angle speed causes too much acceleration of the pressure medium. In particular, as shown in the lower portion of FIG. 4, first the pressure P generated by the first hydraulic machine 4 increases as the pivoting angle a₈ᵢₛₜ of the second hydraulic machine 8 is pivoted towards 0 and the pressure medium accumulates in the working line 6. However, if the pivoting angle a₄ᵢₛₜ of the first hydraulic machine 4 has pivoted above 0, the pressure will suddenly drop, resulting in cavitation. The value of the pressure P will then stabilize to a certain value over time.

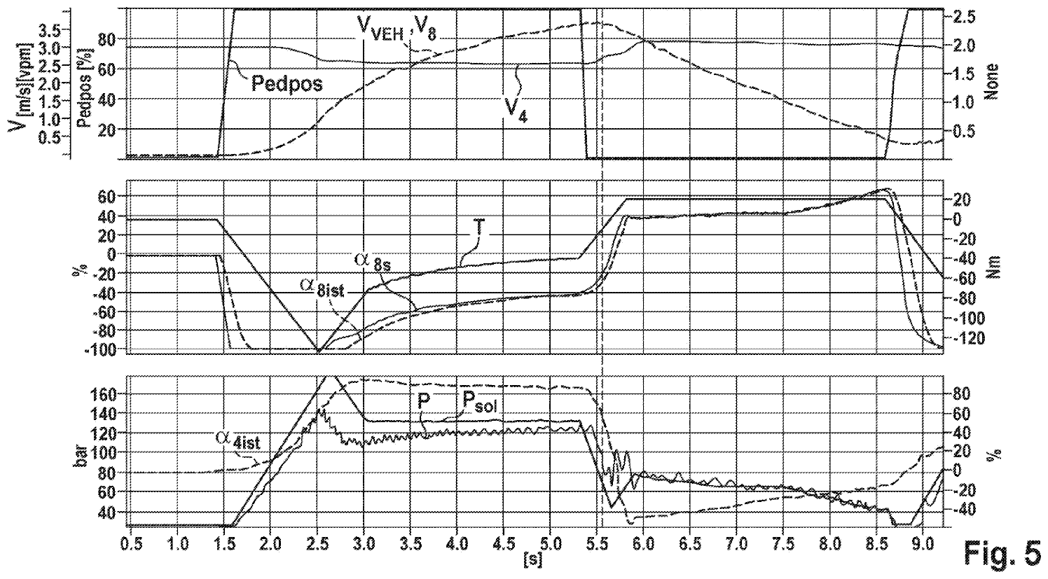

For this reason, the inventor has developed a method for controlling the drive to prevent this instability. In particular, as shown in FIG. 5, according to an embodiment of the present invention, a limitation of the pivoting speed of the pivoting angle a₈ᵢₛₜ of the second hydraulic machine 8 has been made (as can be seen in the course of a₈ᵢₛₜ).

The limitation takes place in particular in an angular, travel or time interval on both sides of the respective zero displacement volume, in particular when the respective hydraulic machine changes from motor operation to pump operation, as there would be a risk of cavitation when the pressure medium is drawn in if the change is too dynamic.

By this limitation, the maximum pivoting speed a₈ᵢₛₜ of the pivoting angle of the second hydraulic machine 8 is limited by not exceeding a predefined value.

In particular, because in this embodiment the second hydraulic machine 8 is torque-controlled by the control unit 28 and the adjustment unit 26 associated therewith, this pivoting angle speed is executed by limiting the torque specification T.

With this solution, as shown in the lower portion of FIG. 5, the pressure P generated by the first hydraulic machine 4 is decreased more slowly, as the pivoting angle a₈ᵢₛₜ of the second hydraulic machine 8 is pivoted towards 0 by means of the limitation described, and at the same time the pivoting angle a₄ᵢₛₜ of the first hydraulic machine 4 is pivoted towards 0.

In particular, in a particular embodiment, the control unit 28 will limit control of the pivoting angle of the second hydraulic machine 8 between the start pivoting angle and the target pivoting angle, such that the torque specification T, in particular a torque specification gradient, of the second hydraulic machine 8 follows a predefined curve.

The target pivoting angle of the second hydraulic machine is selected to be vᵥₑₕ as a function of the travel speed. Preferably, the higher the driving speed vᵥₑₕ, the smaller the absolute value of the target swivel angle. This solution effectively reduces the risk of cavitation. With this solution, the displacement volume Vgp, Vgm is limited to a limit within a time interval extending around the change.

It has been found in connection with the target speed that it is particularly advantageous to increase the working pressure P of the working line 6. With this solution, the working pressure P of the working line 6 is increased within a time interval extending around the change relative to the working pressure outside of that interval. By increasing the pressure, the angle may be smaller to regulate the same torque. As a result, less amount is conveyed while the braking torque is constant, and thus less fluid is also accelerated when changing from motor to pumping operation.

While the present invention has been described with reference to the embodiments described above, it is clear to those skilled in the art that it is possible to realize various modifications, variations and improvements of the present invention in light of the teaching described above and within the scope of the appended claims without departing from the scope of the invention.

In particular, it has been written in the description that the first hydraulic machine 4 is pressure-controlled via the control unit 28 and the associated adjustment unit 24, wherein the working pressure p results from a maximum value of the requirements of travel and working hydraulics. In another exemplary embodiment, the first hydraulic machine may be torque-controlled. In this case, the limitation method may also be used on the first hydraulic machine 4, which is pivoted from a motor operation to a pump operation.

Accordingly, the invention is not intended to be limited by the specific illustrative embodiments, but only by the scope of the appended claims.

1-8. (canceled)

9. A method for controlling a drive, which has at least two hydraulic machines, to change one of the hydraulic machines from pump operation to motor operation and to change the other of the hydraulic machines from motor operation to pump operation, the two hydraulic machines including a first hydraulic machine is configured to couple to a drive machine and a second hydraulic machine is configured to couple to an output, the two hydraulic machines being fluidically connected to one another via a working line and being connected to a pressure medium sink, each of the first and second hydraulic machines having a displacement volume that is adjustable to zero and to values left and right of zero, said hydraulic machines each having, for adjustment purposes, an electrohydraulic adjustment unit that is connectable to the working line and to the pressure medium sink, the method comprising:
controlling the other hydraulic machine so that a pivoting angle goes from a start pivoting angle to a target pivoting angle, wherein (i) the start pivoting angle is positive and the target pivoting angle is negative or (ii) the start pivoting angle is negative and the target pivoting angle is positive,
wherein the control of the other hydraulic machine in an angular, travel, or time interval on both sides of a respective zero displacement volume is limited such that a pivoting speed of the pivoting angle of the other hydraulic machine does not exceed a predefined value.

10. The method according to claim 1, wherein the limiting of the pivoting speed of the pivoting angle of the other hydraulic machine is performed between the start pivoting angle and the target pivoting angle by limiting a torque specification of the other hydraulic machine.

11. The method according to claim 10, wherein a control unit limits control of the pivoting angle between the start pivoting angle and the target pivoting angle such that the torque specification follows a predefined curve.

12. The method according to claim 10, wherein the torque specification is limited such that a torque specification gradient is limited.

13. The method according to claim 9, further comprising:
selecting the target pivoting angle as a function of travel speed.

14. The method according to claim 9, further comprising:
prior to the controlling of the other hydraulic machine, predicting and/or sensing a change of the other hydraulic machine from motor operation to pump operation.

15. The method according to claim 9, further comprising:
during the controlling of the pivoting angle, controlling, with a control unit, the electrohydraulic adjustment unit of one of the two hydraulic machines such that a working pressure of the working line is increased within a time interval extending around the change, relative to the working pressure outside of the time interval.

16. The method according to claim 9, wherein during step a., the electrohydraulic adjustment unit of the one hydraulic machine is controlled via the control unit, such that the displacement volume is limited to a limit within a time interval extending around the change.

17. The method according to claim 9, wherein the drive is a traction drive.
